(19) United States
(12) Patent Application Publication
(10) Pub. No.: US 2025/0389196 A1
(43) Pub. Date: Dec. 25, 2025

(54) ELASTICALLY CENTERED SYNCHRONIZATION DEVICE

(71) Applicant: MTU Aero Engines AG, Muenchen (DE)

(72) Inventor: Alexander BOECK, Kottgeisering (DE)

(21) Appl. No.: 18/644,274

(22) Filed: Apr. 24, 2024

(30) Foreign Application Priority Data
Apr. 27, 2023 (DE) 102023110935.9

(51) Int. Cl. F01D 7/00

(52) U.S. Cl. CPC F01D 7/00; F05D 2260/79

(57) ABSTRACT

A device (1) for the blade adjustment of a turbomachine, including a synchronization device (10), in particular a synchronization ring, and oppositely situated bearing devices (5) that are configured to radially support the synchronization device (10), in particular in a play-free manner, so that the synchronization device (10) may thermally deform, and during the deformation assumes an oval shape, in particular a symmetrical oval shape.

This claims priority to German Patent Application DE 10 2023 110 935.9, filed Apr. 27, 2023 which is hereby incorporated by reference herein.

The present invention relates to a device for the in particular synchronous blade adjustment of a turbomachine.

### BACKGROUND

Synchronization devices for a turbomachine, and the parts of the turbomachine with which the synchronization device interacts, generally have different thermal expansion coefficients, so that synchronization devices, in particular synchronization devices designed as a synchronization ring, are designed with play to compensate for the typically different expansions during operation of the turbomachine. This may result in angular deviations for the blades that are activated by the synchronization device, which in particular reduce the efficiency of the turbomachine.

### SUMMARY OF THE INVENTION

An object of the present invention is in particular to improve a synchronization of adjustable guide blades of a turbomachine, more particularly, to reduce and/or prevent an angular error at the adjustable guide blade, in particular to improve angular accuracy in setting the adjustable airfoils.

In one embodiment of the present invention, a device for the blade adjustment of a turbomachine includes a synchronization device. In one embodiment, the synchronization device is configured to adjust, in particular synchronously, blades of a turbomachine. In one embodiment, the synchronization device is a synchronization ring. In one embodiment, the device includes bearing devices, which in one embodiment are oppositely situated, the bearing devices in particular being situated at the synchronization device in such a way that the synchronization device is supported by the bearing device(s), in particular in a play-free manner. In one embodiment, the bearing devices are designed to support the synchronization device, in particular in such a way that blades of the turbomachine, in particular their incident flow angle, may be adjusted by the synchronization device. In one embodiment, the bearing devices are situated in such a way that the synchronization device in sections may deform at least essentially ovally, in particular symmetrically ovally. In one embodiment, the bearing devices are situated in such a way that the synchronization device as a whole may at least essentially ovally deform or be ovally deformed, the device being configured in particular to allow such a deformation, in particular under thermal load, in particular in such a way that the synchronization device is or may be symmetrically ovally deformed. In one embodiment, the bearing device is configured in such a way that the synchronization device during in particular thermal expansion assumes an oval shape having at least one axis of symmetry, in one embodiment the at least one axis of symmetry being at least essentially situated on a separating plane between the oppositely situated bearing devices. In one embodiment, the bearing devices are configured in such a way that the ovalized synchronization device has at most two axes of symmetry, in particular at most two axes of symmetry that are perpendicular to one another.

In this way, in one embodiment a thermal expansion may be made possible, in particular in such a way that an angular error resulting from the thermal expansion is reduced, in particular at least essentially prevented. In addition, in one embodiment, play of the synchronization device may thus be reduced, in particular in such a way that guiding of the synchronization device is or may be improved. Furthermore, in one embodiment the efficiency of the turbomachine may be improved, in particular compared to a synchronization device that is supported in some other way in which an expansion is compensated for by play.

In this way, in one embodiment it is also possible to reduce wear on the bearing device(s) and/or the synchronization device, in particular compared to a bearing of the synchronization device which at least essentially prevents an in particular thermal expansion. In particular, in one embodiment a bearing device may be dimensioned (more) simply, since the bearing devices advantageously experience little/fewer, in particular no, forces due to the thermal expansion of the synchronization device, or are designed or have to be designed for them, in particular compared to a bearing of the synchronization device that radially supports the synchronization device over its, in particular entire, circumference.

In one embodiment, the synchronization device is a unison ring, or in one embodiment the term “synchronization device” used herein is preferably understood as a unison ring.

The term “oval” as used herein is to be understood in particular as a round convex figure, and in one embodiment may in particular have one or multiple axes of symmetry, in particular axes of symmetry situated perpendicular with respect to one another.

In one embodiment, the synchronization device is designed in such a way that during an expansion, in particular a thermal expansion, or the ovalization of the synchronization device, (only) forces occur that cause no (elastic and/or plastic) deformation of other parts of the device or of the system (see below), in particular that do not deform the housing of the turbomachine.

It may thus advantageously be made possible that effects of expansion(s), in particular thermal expansion(s), on the adjustment accuracy of the guide blades are or may be at least essentially completely compensated for. In one embodiment, a higher efficiency of the turbomachine may thus be achieved, and in particular wear on the bearing devices or centering devices of the synchronization device may be reduced, in particular at least essentially avoided. In one embodiment, the operating costs of the turbomachine may thus be small (er) or reduced.

In one embodiment, it may thus advantageously be made possible that a synchronization device is or may be supported, in particular in a play-free manner, in particular that no thermal stresses are introduced into the synchronization device. In one embodiment, the synchronization device may advantageously thermally deform without an angular error at 90° with respect to the bearing device being caused or occurring.

In one embodiment, the device is designed for guiding, in particular centering, the synchronization device or is used for this purpose. In one embodiment, the device is designed to radially support the synchronization device, in particular to radially support it in a play-free manner, in particular in a “cold” state of the turbomachine or when the turbomachine is not in operation.

In one embodiment, an oval, in particular elliptical, deformation of the synchronization device may thus advantageously be made possible, and in particular angular deviations or angular errors of the guide blades with regard to a thermal expansion may be compensated for or minimized, in particular prevented, in particular due to the ovalization of the synchronization device.

In one embodiment, the bearing device is designed as a swivel lever or includes at least one swivel lever. In one embodiment, the lever length is at least essentially identical to a position and to a rotational axis of an adjustable blade of the turbomachine. In one embodiment, the swivel levers of the bearing device(s) are configured in such a way that the synchronization device assumes an oval, in particular symmetrically oval, shape during a thermal expansion of the synchronization device.

In one embodiment, it may thus advantageously be made possible that the synchronization device is guided in such a way that it is or may be ovally deformed during thermal expansion. In particular for blades that are offset by 90° with respect to the bearing device, an angular error is thus reduced or in particular at least essentially prevented.

In one embodiment, it may thus advantageously be made possible that in particular different thermal expansions do not result in a shift of the midpoint of the synchronization device, in particular in relation to a rotational axis of the blades, and in particular a maximum angular error is or may be minimized, more particularly minimized in a position that is situated or shifted in particular at/by 90° with respect to the bearing device, in particular in relation to an in particular correspondingly situated (guide) blade axis, and more particularly, at least essentially no angular error occurs at this position.

In one embodiment, the bearing devices, in particular in each case, are designed as rollers. In one embodiment, the bearing devices include at least one shaft, in particular with at least one bearing on which the roller is situated. In one embodiment, the roller is situated radially with respect to the synchronization device and supports it, and in one refinement supports it radially in a play-free manner. In one embodiment, the bearing devices are situated in such a way that they are oppositely situated, in particular in such a way that the synchronization device assumes or may assume an oval shape during in particular thermal expansion, more particularly assumes or may assume a symmetrical oval shape that in particular is symmetrical with respect to an axis that is situated centrally perpendicularly on an (imaginary) connection between the bearing devices.

In one embodiment, it may thus advantageously be made possible that the synchronization device is at least essentially automatically ovalized during thermal expansion, and in one embodiment is supported, in particular in a play-free manner, by the rollers of the bearing device.

In one embodiment, in the radial direction the shaft of the bearing device includes a first bearing, or in one embodiment a first bearing is situated on the shaft. In one embodiment, the shaft or the first bearing includes a second bearing that is radially situated on the first bearing. In one embodiment, the roller includes a first bearing, in particular a first bearing and a second bearing. In one embodiment, the bearings are situated radially with respect to one another, in particular with the second bearing radially situated on the first bearing, and in particular the first bearing and the second bearing are situated concentrically with respect to one another. In one embodiment, the first bearing is a linear ball bearing. In one embodiment, the second bearing is a needle bearing or a needle bush.

In one embodiment, the shaft is fixedly, in particular rotatably fixedly, connected to a housing of the bearing device. In one refinement, the shaft of the bearing device is radially adjustable, in particular in such a way that a synchronization device may be supported in a play-free manner, and in particular the play of the synchronization device is or may be adjustable.

It may thus advantageously be achieved that play of the synchronization device is adjustable, and in particular the synchronization device, in particular its play, is adjustable to operating conditions.

In one embodiment, the roller includes a receptacle, in particular a groove. In one embodiment, the receptacle, in particular the groove, is configured to accommodate the synchronization device, in particular radially or perpendicularly with respect to the rotational axis of the turbomachine and/or the axis of the blades.

In one embodiment, the groove of the roller is configured to laterally support, in particular guide, the synchronization device, in particular to support the synchronization device in a play-free manner.

In one embodiment, play which is generally detrimental may thus be advantageously reduced and/or avoided.

In one embodiment, the bearing devices are at least essentially situated in an area in which the synchronization device is mechanically connected to a master-master adjustment [system], in particular is configured for this purpose, or in which a master-master adjustment [system] is used.

In one embodiment, it may thus advantageously be made possible that the synchronization device, in particular at the activation points of the master-master adjustment system, is or may be at least essentially supported in a play-free manner.

In one embodiment, the device includes exactly two or exactly four bearing devices, which in one refinement are oppositely situated relative to the synchronization device, and/or are oppositely situated relative to the housing of the turbomachine.

In one embodiment, the device includes at least one housing in which the adjustable airfoils are supported, in particular centered.

In one embodiment of the present invention, a system for in particular synchronous blade adjustment of a turbomachine is provided. In one embodiment, the system includes a device that is described herein. In one embodiment, the system includes a turbomachine, in particular a turbine or a compressor, more particularly, a turbine stage or a compressor stage, in particular including a housing. In one embodiment, the system includes at least one first and one second, in particular adjustable, guide blade, the guide blade or its guide blade arms being centered by the housing. In one embodiment, the system includes a turbine and/or a compressor, and in particular the system may be a turbomachine, in particular a turbine and/or a compressor, more particularly, a turbine stage and/or a compressor stage, more particularly, a gas turbine, more particularly, a jet engine, in particular for an aircraft, in particular a low-pressure turbine of an aircraft engine.

In one embodiment, the system includes at least one device described herein.

In one embodiment, it is thus advantageously possible to reduce wear, in particular to extend maintenance intervals, in particular for the device described herein.

### BRIEF DESCRIPTION OF THE DRAWINGS

Further advantageous refinements of the present invention result from the subclaims and the following description of preferred embodiments. Some of the figures are shown in a schematic fashion:

FIG. 1 shows a synchronization device according to the related art;

FIG. 2 shows one specific embodiment of a device;

FIG. 3 shows a detailed view of a roller of one specific embodiment of the device in a top view A and a sectional view B; and

FIG. 4 shows one alternative specific embodiment of the device.

### DETAILED DESCRIPTION

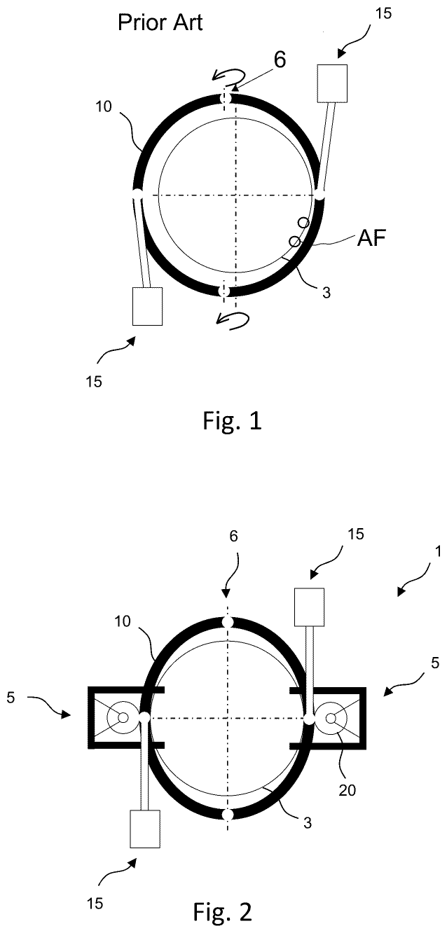

FIG. 1 shows a device for adjusting airfoils of a turbomachine of the related art. This device has play between synchronization device 10, and a housing 3 in which adjustable airfoils AF shown solely schematically are supported. In addition, a first activation device 15 and a second activation device 15 of a master-master adjustment system are schematically illustrated, the master-master adjustment system including two schematically illustrated actuators that are configured to adjust or set synchronization device 10. As a result of thermal expansion, in particular the midpoint of synchronization device 10 is shifted relative to a midpoint of housing 3. This results in maximum angular errors at a position that is offset by 90° with respect to the activation position of activation devices 15 (see e.g. position 6 in FIG. 2). Depending on the displacement of synchronization device 10, this may be a maximum positive angular error between first and second activation devices 15 and a negative angular error between second and first activation devices 15, or vice versa, viewed in the clockwise direction.

FIG. 2 schematically shows one specific embodiment of a device 1 that includes a bearing device 5, situated in the area of the activation position of an activation device 15 of a master-master system. Bearing device 5 includes rollers that support synchronization device 10 in a radially play-free manner, in particular in the area of the activation position. The rollers of bearing device 5 allow a movement of synchronization device 10 in the circumferential direction of housing 3, and at the same time allow a play-free bearing in the area of the activation position. In the schematic illustration, synchronization device 10, which is illustrated as a synchronization ring by way of example, has a different thermal expansion than housing 3. Bearing device 5 allows or causes ovalization of synchronization device 10, as schematically illustrated here, with consistent bearing at bearing device 5 in embodiments. This reduces the angular error in a position 6 (or both positions 6), which is/are situated at 90° with respect to the position of bearing device 5, or an angular error is thus at least essentially prevented.

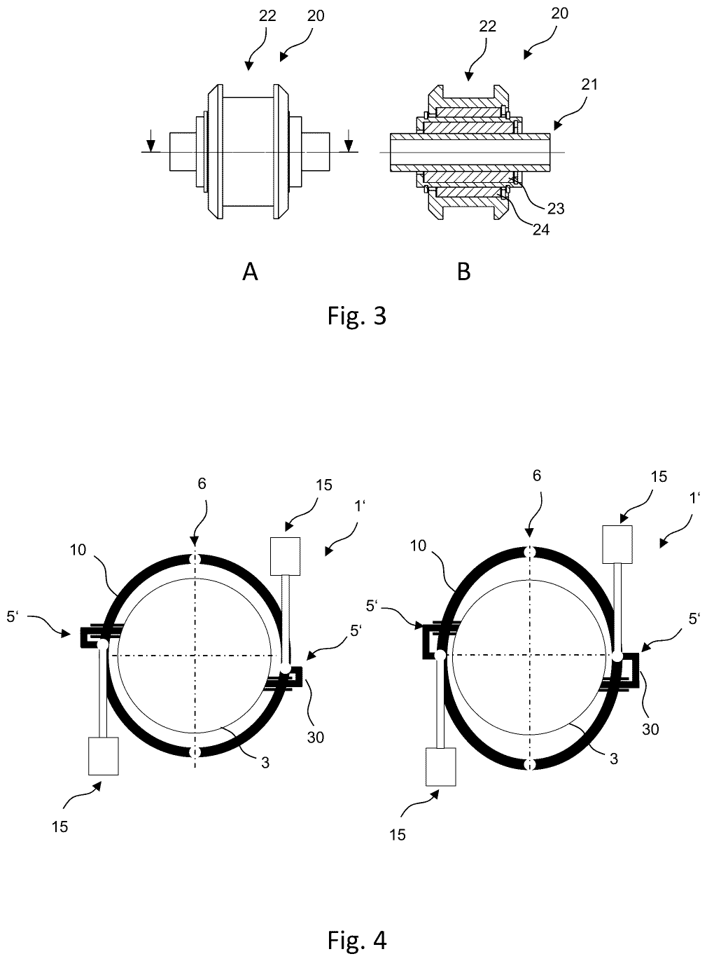

FIG. 3 schematically shows a detailed view of a bearing device 5 in a top view A and a corresponding sectional view B, which with the aid of a roller 20 allows an at least essentially play-free bearing or is designed for this purpose. Bearing device 5 includes a shaft 21 that is rotatably fixedly connected to a housing of the bearing device. In addition, roller 20 includes a groove 22 that is designed to axially guide the roller at synchronization device 10. In one embodiment, shaft 21 may be a solid shaft and/or a hollow shaft, and in the present case is illustrated as a hollow shaft by way of example. In one embodiment, the axis of roller 20 or the shaft is adjustable, in particular to adjust play of synchronization device 10. In one embodiment, the shaft may be adjusted radially with respect to a midpoint of housing 3 or is designed for this purpose, so that in particular play of synchronization device 10 may be adjusted or is adjustable. In addition, a radial arrangement of two bearings 23, 24 is shown in FIG. 3B. In one embodiment, first bearing 23 may be a linear ball bearing. In one embodiment, second bearing 24 may be a needle bearing or a needle bush.

FIG. 4 schematically shows one specific embodiment of a device 1′ including a bearing device 5′ that is configured with the aid of two swivel levers 30, so that during an in particular thermal expansion, synchronization device 10 is ovalized or may ovalize. As schematically illustrated, swivel levers 30 in their length and/or position of the rotational axis are at least essentially identical to the activation length and/or the position of the rotational axis of the levers of the adjustable blades. The symmetrical ovalization that results during the adjustment advantageously has no effect on the adjustment angles of the blades, but advantageously avoids detrimental play which is generally used to compensate for different, in particular thermal, expansions of the components. In this regard, on the left side FIG. 4 shows a first state of device 1′, and on the right side shows a second state in which synchronization device 10 is illustrated in an ovalized state. An angular deviation at position 6, i.e., offset by 90° with respect to the position of bearing device 5′, is reduced or prevented by the ovalization of synchronization device 10. Activation devices 15 are illustrated in a master-master configuration, and control synchronization device 10 in an area in which bearing devices 5′ act. On the left side of FIG. 4, device 1′ is illustrated in a nonovalized form, and the right side shows synchronization device 10 in an ovalized form.

Although exemplary embodiments have been explained in the preceding description, it is pointed out that numerous modifications are possible. Furthermore, it is pointed out that the exemplary embodiments are strictly examples, which in no way are intended to limit the scope of protection, the applications, and the design. Rather, the preceding description provides those skilled in the art with guidelines for implementing at least one exemplary embodiment, it being possible to make various changes, in particular with regard to the function and arrangement of the described components, without departing from the scope of protection that results from the claims and feature combinations equivalent to same.

What is claimed is:

1. A device for blade adjustment of a turbomachine, the device including:
a synchronization device for adjusting blades of the turbomachine; and
oppositely situated bearings configured to radially support the synchronization device in a play-free manner, so that the synchronization ring may thermally deform to assume an oval shape.

2. The device as recited in claim 1 wherein the oval shape is symmetrical symmetrical.

3. The device as recited in claim 1 wherein the bearings in each case include at least one roller configured to support the synchronization device.

4. The device as recited in claim 3 wherein the bearings each include at least one shaft with at least one roller bearing, the at least one roller situated on the roller bearing.

5. The device as recited in claim 1 wherein the at least one roller bearing includes in a radial direction of the shaft, a first bearing situated on the shaft, and in the radial direction a second bearing situated on the first bearing.

6. The device as recited in claim 4 wherein the shaft is fixedly connected to a housing of the bearing.

7. The device as recited in claim 4 wherein the shaft is radially adjustable with respect to the synchronization device or to a rotational axis of the turbomachine.

8. The device as recited in claim 3 wherein the roller includes a receptacle configured to accommodate the synchronization device.

9. The device as recited in claim 8 wherein the receptacle is a groove.

10. The device as recited in claim 1 wherein the bearing device includes at least one swivel lever mechanically connected to the synchronization device.

11. The device as recited in claim 10 wherein a lever length of the swivel lever and a position of the rotational axis of the swivel lever are identical to a position and to a rotational axis of an adjustable blade of the turbomachine.

12. The device as recited in claim 1 wherein the bearing devices number exactly two.

13. The device as recited in claim 1 further comprising an adjustment system, and the synchronization device being adjusted with the aid of the adjustment system, designed in a master-master configuration.

14. The device as recited in claim 1 wherein the synchronization device is a synchronization ring.

15. A turbomachine comprising adjustable blades, and at least one device as recited in claim 1 for adjusting these blades.
